(19) United States
(12) Patent Application Publication
(10) Pub. No.: US 2015/0122408 A1
(43) Pub. Date: May 7, 2015

(54) NAPKIN

(71) Applicant: Gant Innovations Limited, Tyne And Wear (GB)

(72) Inventor: Gail Shaw, Tyne And Wear (GB)

(21) Appl. No.: 14/536,095

(22) Filed: Nov. 7, 2014

Related U.S. Application Data
(62) Division of application No. 13/499,065, filed on Mar. 29, 2012, now abandoned.

(30) Foreign Application Priority Data
Sep. 29, 2009 (GB) 0917051.5
Oct. 21, 2009 (GB) 0918432.6

(51) Int. Cl. B31F 1/00; B31D 1/04

(52) U.S. Cl. CPC B31F 1/0016; B31D 1/04
USPC 156/227; 156/443

(57) ABSTRACT

A method of applying adhesive to a napkin includes spraying first and second adhesive portions on to a first surface of a napkin, and folding the napkin along a fold such that the first and second adhesive portions are brought into engagement with each other, in which the adhesive is of a type that will allow the first and second adhesive portions to separate and allow the napkin to be adhered to an object.

The present invention relates to the application of adhesive to a napkin, and relates particularly but not exclusively, to the application of adhesive to a napkin for the purpose of adhering the napkin to a person.

When sitting eating a meal people typically place a napkin on their lap or tuck a napkin into their clothes to prevent any misplaced food/drink from coming into contact with their clothes thereby causing stains. However, napkins tend to slide off all types of clothing, in particular sheer materials such as silk and therefore do not provide the protection outlined above when needed most for example when wearing an expensive dress at a dinner party.

A known solution to this problem is to apply double sided sticky tape to a napkin. However, applying the double sided sticky tape requires a certain degree of human dexterity which may only be copied by a complex machine. Also, waste is produced during the implementation of this solution because the material peeled away from the double sided sticky tape in order to expose the adhesive needs to be disposed of. Furthermore, double sided sticky tape is expensive. These three factors prohibit the implementation of this known solution on a mass scale.

Preferred embodiments of the present invention seek to overcome the above disadvantages of the prior art.

According to a first aspect of the present invention there is provided a napkin comprising:

a sheet having a first surface; and

first and second adhesive portions adhered to the first surface;

wherein the first and second adhesive portions are adapted to engage each other when the sheet is folded along a first fold, and the adhesive is of a type that will allow the first and second adhesive portions to separate and allow the sheet to be adhered to an object.

By placing two portions of adhesive on a napkin in such a position that they come into engagement with one another when the napkin is folded provides the advantage that the napkin can be subsequently unfolded and adhered to an object such as a person or a person's clothes. Also because expensive double sided sticky tape need not be used to realise the present invention the need to dispose of backing strips is eliminated. This provides the advantage of significantly reducing manufacturing costs, from the high cost of using double-sided tape seen the in prior art.

Furthermore, due to the elimination of the requirement for backing strips, less dexterity is required to apply adhesive to a napkin. The present invention may therefore be implemented quicker using less complicated machinery than that which is already known thus providing the advantages of further reducing the cost of, and increasing the speed at which, the solution embodied by the present invention may be implemented.

One of the most significant cost factors in the production of napkins is transportation. This results from the very light-weight nature of this product making it inefficient to transport in that the vehicle carrying the product is capable of carrying significantly heavier goods within its volume. It is therefore important in the transportation of napkins that the packaged product is transported in as compacted and compressed form as possible. The use of double-sided tape (or any other reinforcing tape) will increase the bulk of the napkins within their packaging meaning that fewer napkins can be transported per unit of volume. The volume of and weight of the napkins of the present invention is barely distinguishable from that of a plain napkin without adhesive and therefore can be treated exactly like a non-adhesive napkin of the prior art. Indeed once the adhesive has been applied and the first fold has been made, the napkin can then be handled in exactly the same manner as a non-adhesive napkin.

It is also the case that heavy woven (non-disposable) napkins are often used to reduce the likelihood of then being dislodged since the heavier fabric is less likely to be blown off the lap of the person wearing it. Although the present invention is equally applicable to heavy fabric napkins, further reducing the likelihood slippage, the present invention means that there is less need to use such heavy material which reduces the cost of laundry or makes disposable napkins a more environmentally sustainable alternative.

Furthermore, the present invention is of particular use for people of limited mobility or in places where mobility is limited. For example, the elderly, people with certain movement limiting disabilities and children may easily loose their napkin and not be able to retrieve it. Similarly in cramped conditions, such as on an aeroplane it may not be easy to reach a dropped napkin. For people who are partially sighted, and for the fully sighted in low light conditions, it is easy to not realise that a napkin is no longer in position. Because the present invention ensures the napkin remains in place this problem is alleviated.

In a preferred embodiment the first and said second adhesive portions together form a strip of adhesive extending along said first surface perpendicular to said first fold.

This allows the edge of the napkin to which the adhesive has been applied to, or applied adjacent to, to be folded over allowing the napkin to be stuck to itself thereby providing the advantage of allowing the napkin to be used as a regular napkin which does not adhere to objects if a user so requires.

In a preferred embodiment the first and second adhesive portions together form a strip of adhesive extending along the first surface perpendicular to the first fold.

By applying a strip of adhesive to a napkin allows the above advantages to be realised at the same time as maximising the speed of the manufacturing process.

In another preferred embodiment the napkin further comprises at least one second fold.

This provides the advantage of minimizing the size of the folded napkin.

According to another aspect of the present invention there is provided a method of applying adhesive to a napkin, the method comprising the steps of:

applying first and second adhesive portions to a first surface of a napkin; and

folding the napkin along a first fold such that the first and second adhesive portions are brought into engagement with each other;

wherein the adhesive is of a type that will allow the first and second adhesive portions to separate and allow the napkin to be adhered to an object.

In a preferred method the first and second adhesive portions together form a strip of adhesive extending along the first surface perpendicular to the first fold.

In another preferred method there is also included the step of folding the napkin along at least one second fold.

In a further preferred method the adhesive is sprayed onto the first surface.

This provides the advantage of further increasing the speed of the manufacturing process.

According to another aspect of the present invention there is provided a napkin comprising:

a sheet;

first and second adhesive portions adhered to a surface of the sheet; and

first and second removable cover portions at least partially adhered to the first and second adhesive portions respectively, the first and second cover portions each having a tab portion adapted to be grasped by a user;

wherein the first and second cover portions are adapted to be removed from the sheet by applying a force to the respective tab portions in opposing directions towards respective opposing edges of the sheet thereby exposing the adhesive to allow the sheet to be adhered to an object.

The use of tabs extending from the cover portions which are adapted to be pulled in opposing directions allows two cover portions to be removed from a napkin in a single action. This provides the advantage of maximising the speed and ease with which adhesive applied to a napkin may be exposed in order for the napkin to be used in accordance with the present invention.

In a preferred embodiment the tab portions are located away from the respective opposing edges towards which they are pulled when removed from the sheet.

In another preferred embodiment the first and second cover portions are adapted to engage each other when the sheet is folded along a first fold.

In a further preferred embodiment the first and second adhesive portions together form a strip of adhesive extending along the first surface.

By applying a strip of adhesive to a napkin allows the previously mentioned advantage to be realised at the same time as maximising the speed of the manufacturing process.

In a preferred embodiment the napkin further comprises at least one second fold.

According to another aspect of the present invention there is provided an apparatus for applying adhesive to a napkin, the apparatus comprising:

adhesive applying means for applying first and second adhesive portions to a first surface of a napkin; and

first folding means for folding said napkin along a first fold such that said first and said second adhesive portions are brought into engagement with each other;

wherein said adhesive is of a type that will allow said first and said second adhesive portions to separate and allow said napkin to be adhered to an object.

In a preferred embodiment the adhesive applying means applies said first and said second adhesive portions together form a strip of adhesive extending along said first surface perpendicular to said first fold.

The apparatus may further comprise second folding means for folding said napkin along at least one second fold.

In another preferred embodiment the adhesive applying means sprays said adhesive onto said first surface.

According to a further aspect of the present invention there is provided a napkin manufacturing apparatus comprising sheet material forming apparatus for forming at least one sheet material;

cutting means for cutting said sheet into napkins; and

adhesive applying apparatus as set out above.

In a preferred embodiment the adhesive is applied to said sheet material before said sheet material is cut into napkins

Preferred embodiments of the invention will now be described, by way of example only and not in any limitative sense, with reference to the accompanying drawings in which:

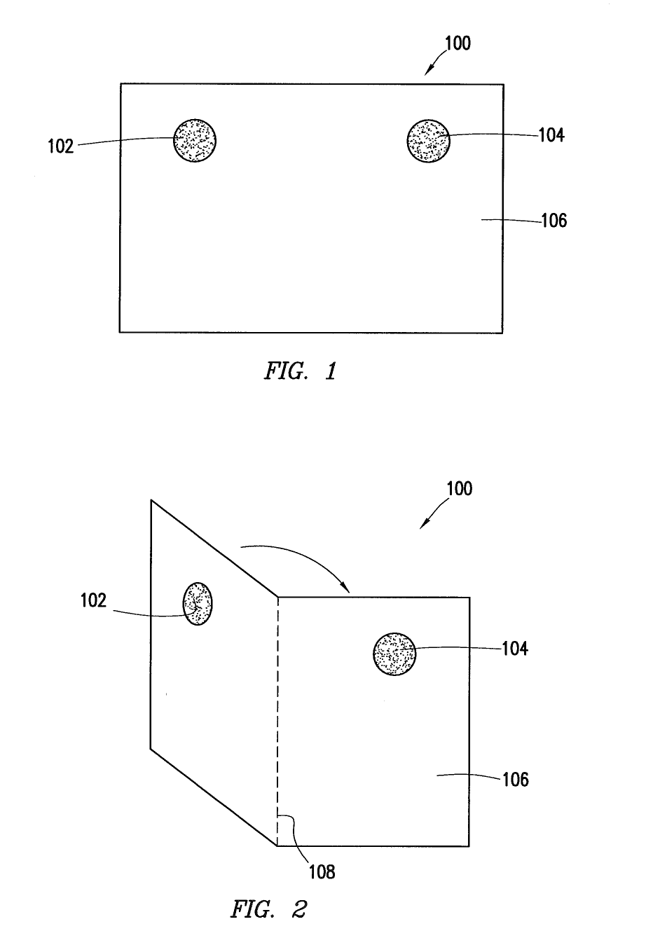

FIG. 1 is a perspective view of a napkin to which adhesive has been applied in accordance with a first embodiment of the present invention;

FIG. 2 is a perspective view of the napkin in FIG. 1 into which a first fold is being introduced;

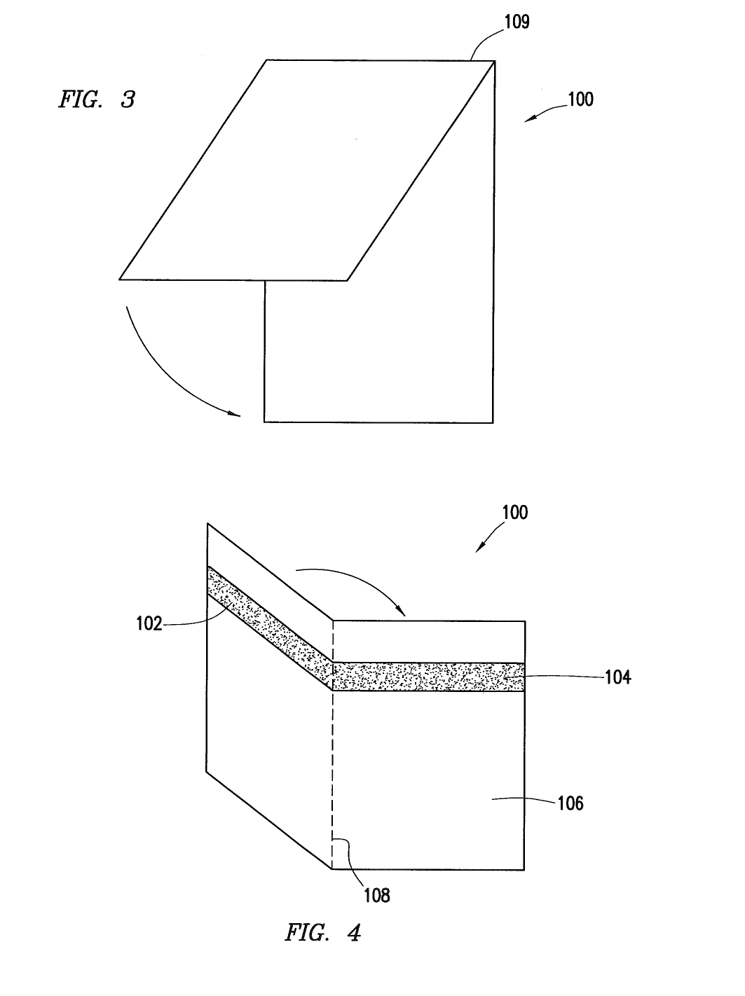

FIG. 3 is a perspective view of the napkin in FIG. 2 into which a second fold is being introduced;

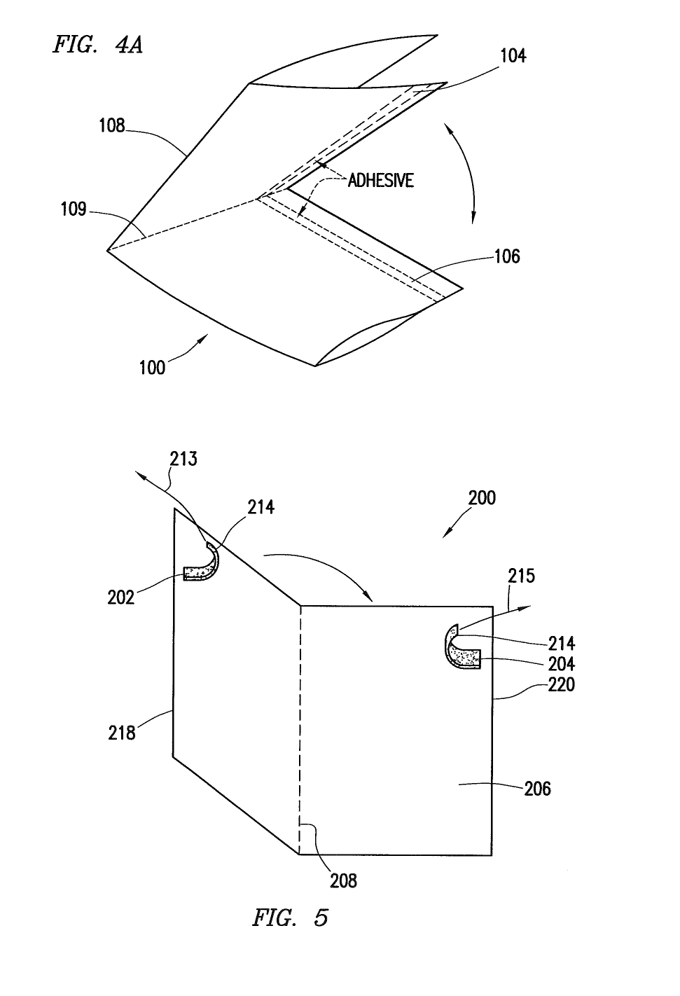

FIG. 4 is a perspective view of a napkin to which adhesive has been applied in accordance with a second embodiment of the present invention;

FIG. 4A is a perspective view of the napkin in FIG. 4 into which first and second folds have been introduced;

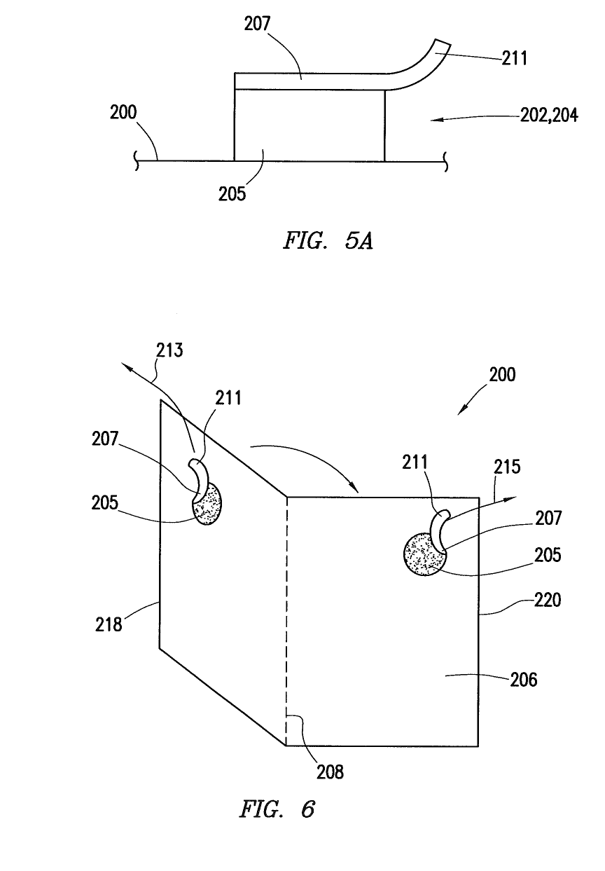

FIG. 5 is a perspective view of a napkin to which adhesive has been applied in accordance with a third embodiment of the present invention;

FIG. 5A is a cross sectional view of a tape portion which has been applied to the napkin in FIG. 5;

FIG. 6 is a perspective view of the napkin in FIG. 6 being prepared for use;

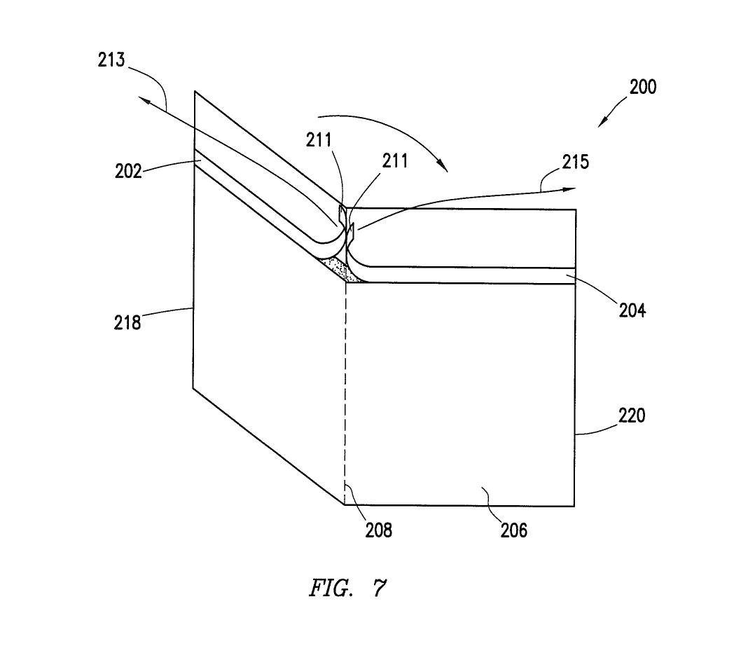

FIG. 7 is a perspective view of a napkin to which adhesive has been applied in accordance with a fourth embodiment of the present invention;

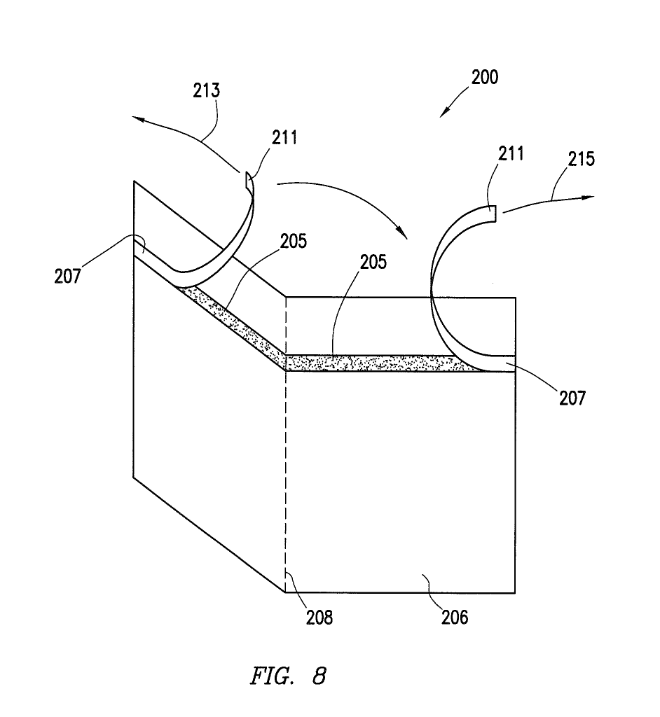

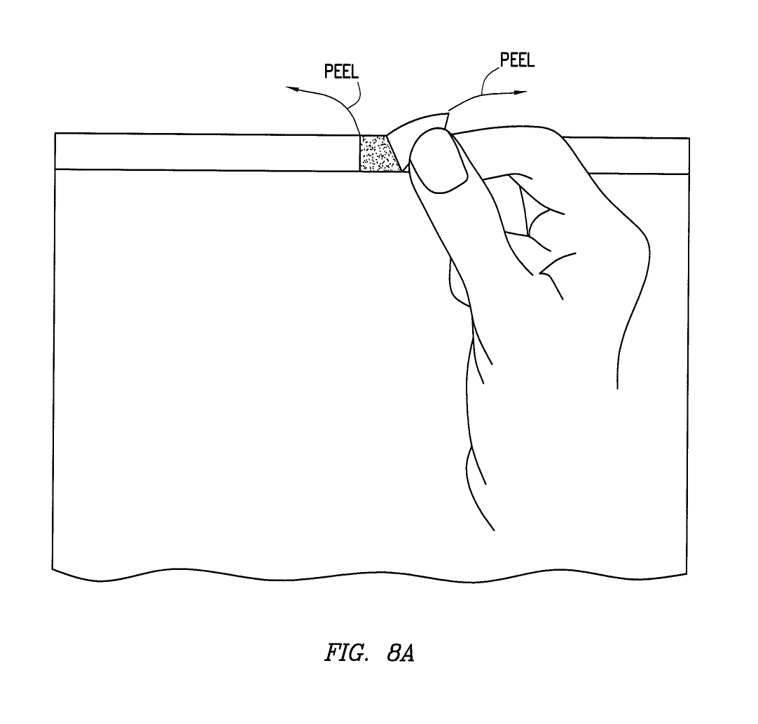

FIG. 8 is a first perspective view of the napkin in FIG. 7 being prepared for use; and

FIG. 8A is a second perspective view of the napkin in FIG. 7 being prepared for use.

In order to modify a napkin 100 in accordance with the present invention adhesive must be applied to it. In accordance with the first embodiment of the present invention, first and second adhesive portions 102, 104 are applied to a first surface 106 of a napkin 100, as shown in FIG. 1. Typically such adhesive may be applied by spraying it directly onto the napkin 100 but may be done using any other method. The napkin 100 is then folded along a first fold 108 so that the first and second adhesive portions 102, 104 are brought into engagement with each other, as shown in FIG. 2. The napkin 100 may then be folded along a second fold 109, see FIG. 3. Any other number of folds may be further introduced into the napkin 100 so that the folded napkin is of a required size.

The adhesive of the first and second adhesive portions 102, 104 is to be of a type that will allow the first and second adhesive portions 102, 104 to separate so that after unfolding a napkin 100 which was previously folded like in FIG. 2, the napkin may to be subsequently adhered to a person, a person's clothing, or any other object. An example of an adhesive product that can be used in the implementation of the present invention is 3M's “Re-Mount” spray or any similar product that can be sprayed onto a surface and adhered to another surface. Another example is the 3M product sold under the brand “Spray 75” which is also a repositionable adhesive. In selecting the adhesive used consideration must be give to the fact paper napkins are often compressed in order to remove air from the packaging and thereby reduce the volume of the packaged napkin for transportation and storage. This causes the layers of adhesive to be pressed into close engagement and can cause the bonding between the adjacent layers of adhesive to be too strong leading to the napkins becoming damaged on opening. This is not the case when the Re-Mount Spray is applied.

In accordance with a second embodiment of the present invention the first and second adhesive portions 102, 104 may together form a strip of adhesive extending along the first surface 106 perpendicular to the first fold 108, as shown in FIG. 4. This strip may be right on the edge of the napkin 100 or simply adjacent to the edge.

Referring to FIG. 5 in which parts in common with those in FIG. 1 have been labelled with like reference numerals increased by 100, a napkin 200 modified in accordance with a third embodiment of the present invention will now be described. In this embodiment instead of simply applying a body of adhesive onto a napkin 200 the use of first and second double sided sticky tape portions 202, 204 is required. Such portions will hereon in be referred to as first and second tape portions 202, 204.

The tape portions 202, 204, illustrated in FIG. 5A, are made up of a layer of tape 205 to which adhesive has been applied to both sides, one side of which is adhered to the surface of a napkin 200. The other side of the tape 205 has a removable cover 207 partially adhered to it. The part of the cover 207 which is not adhered to the tape 205 is referred to as the tab 211. The tab 211 is adapted to be grasped by a user and pulled in order to remove the cover 207 from the tape 205 so as to expose the adhesive thereby enabling the napkin 200 to be used in accordance with the present invention, that is enabling the napkin to be adhered to a person, a person's clothing, or any other object.

With reference to FIG. 6 typically the tab portion 214 of the tape portions 202, 204 are located away from the respective opposing edges 218, 220 of the napkin 200 towards which the tabs 211 are intended to be pulled by applying forces along directions 213, 215 so as to peel the covers 207 from the napkin 100.

In accordance with a fourth embodiment of the present invention the first and second tape portions 202, 204 may together form a strip extending along the first surface 206 of a napkin 200 perpendicular to the first fold 208, the strip being made up of two elongate tape portions 202, 204 which engage each other adjacent their respective tabs 211, see FIGS. 7 and 8. FIG. 8A shows the covers 207 being peeled away from the napkin 200 in FIG. 7 by a person.

It will be appreciated by persons skilled in the art that the above embodiments have been described by way of example only and not in any limitative sense, and that various alterations and modifications are possible without departure from the scope of the invention as defined by the appended claims. For example, the napkin 100, 200 may comprise a sheet of paper, card, cloth or any other material. Furthermore, a napkin 100, 200 may be folded before adhesive portions 102, 104, 202, 204 are applied to it in accordance with any aspect of the present invention. By folding the napkin in half first, then applying a line of adhesive to the napkin parallel to the fold before folding the napkin for a second time, perpendicular to the first fold, the advantage is provided that when the adhesive portions have been separated, the napkin can be attached to the clothes, for example at chest height. The weight of the napkin then causes the first fold to open. It should also be noted that the present invention can be applied any form of napkin including paper napkins of one or multiply plies and woven fabric napkins

Furthermore, it will be apparent that the apparatus for applying adhesive can be part of a napkin manufacturing machine. The device that applies the adhesive may be a retro-fit to an existing napkin making machine or may be formed as part of a napkin making device. The napkins are formed from a larger sheet of material and the adhesive may be applied either before or after the sheet is cut into individual napkins.

What is claimed is:

1. A method of applying adhesive to a napkin, the method comprising the steps of:
spraying first and second adhesive portions on to a first surface of a napkin; and
folding the napkin along a fold such that the first and second adhesive portions are brought into engagement with each other;
wherein the adhesive is of a type that will allow the first and second adhesive portions to separate and allow the napkin to be adhered to an object.

2. A method according to claim 1, wherein the first and second adhesive portions together form a strip of adhesive extending along the first surface perpendicular to the fold.

3. A method according to claim 2, wherein the strip of adhesive is located on an edge of the napkin or adjacent to an edge of the napkin.

4. A method according to claim 1, further including the step of folding the napkin along at least one second fold.

5. A method according to claim 1, wherein the napkin comprises a sheet of paper, card, cloth or any other material.

6. A method according to claim 5, wherein the napkin is a paper napkin having one or multiple plies or a woven fabric napkin.

7. A method according to claim 1 comprising the step of folding the napkin before spraying first and second adhesive portions on to a first surface of the napkin.

8. An apparatus for applying adhesive to a napkin, the apparatus comprising:
adhesive applying means operable to spray first and second adhesive portions on to a first surface of a napkin; and
first folding means for folding said napkin along a fold such that said first and said second adhesive portions are brought together;
wherein said adhesive is of a type that will allow said first and said second adhesive portions to separate and allow said napkin to be adhered to an object.

9. An apparatus according to claim 8, wherein the adhesive applying means is operable to apply said first and said second adhesive portions together to form a strip of adhesive extending along said first surface perpendicular to said fold.

10. An apparatus according to claim 9, wherein the strip of adhesive is located on an edge of the napkin or adjacent to an edge of the napkin.

11. An apparatus according to claim 8 further comprising second folding means for folding said napkin along at least one second fold.

12. A napkin manufacturing apparatus comprising sheet material forming apparatus for forming at least one sheet material; cutting means for cutting said sheet into napkins; and adhesive applying apparatus according to claim 8.

13. A napkin manufacturing apparatus according to claim 12, wherein the adhesive is applied to said sheet material before said sheet material is cut into napkins or the adhesive is applied to said sheet material after said sheet material is cut into napkins.
